(19) United States
(12) Patent Application Publication
(10) Pub. No.: US 2015/0081501 A1
(43) Pub. Date: Mar. 19, 2015

(54) COLLATERAL ARRANGEMENT AGGREGATOR AND NETTING SYSTEM AND METHOD

(71) Applicant: THE BANK OF NEW YORK MELLON, New York, NY (US)

(72) Inventors: Nadine S. CHAKAR, New York, NY (US); Jonathan BOWLER, Kent (GB); William FILONUK, JR., New York, NY (US)

(21) Appl. No.: 14/026,968

(22) Filed: Sep. 13, 2013

(51) Int. Cl. G06Q 40/04

(52) U.S. Cl. CPC G06Q 40/04
USPC 705/37

(57) ABSTRACT

Processors, at an agent of an asset owner, execute program modules to receive first and second exposure information respectively from first and second investment managers associated with the asset owner. The first exposure information comprising a first portion associated with a first counterparty and a second portion associated with a second counterparty, while the second exposure information comprises a third portion associated with the first counterparty and a fourth portion associated with the second counterparty. The modules net the first and third portions, and the second and fourth portions, to compute exposures for the first and second counterparties, fund a collateral account associated with the agent based on portions of the exposure for each of the first and second counterparties attributable to one or more of the first and second investment managers, and initiate settlement of the exposure for each of the first and second counterparties from the collateral account.

### BACKGROUND

This application is directed to computer-implemented systems and methods useful for collateral management. While aspects of this application may be associated with various types of collateral allocations, the computerized systems and methods for allocating collateral described herein may be in reference to centralizing collateral management at an asset owner level.

Changes in market regulations make desirable mechanisms for coping with such regulatory regimes. For example, the promulgation of the Dodd-Frank Wall Street Reform and Consumer Protection Act (“Dodd-Frank”) and its European counterpart, the European Market Infrastructure Regulation (“EMIR”), requires financial entities not only to cover their mark-to-market outlays daily with collateral, but also to provide a deposit for the initial margin regardless of whether the financial entity or another party is clearing a trade.

Presently, asset owners or plans with multiple sub-finds or investment managers delegate to the investment manager(s) responsibility to negotiate and operate credit support agreements for over the counter (OTC) or the futures commission merchant (FCM) relationship for cleared OTC and exchange traded derivatives (ETD) relationships. Because it is likely that there will be transactions with the same counterparty or FCM that can be netted across the funds, such delegation by the asset owners or plans is inefficient.

Among other things, what is needed is a system and method for providing collateral management services to an asset owner or plan that facilitates netting of transactions across investment managers, to optimize use of collateral while reducing counterparty risk.

### SUMMARY

Various embodiments of this disclosure may be used in conjunction with existing financial services platforms, for example the Bank of New York Mellon's Tri-Party repurchase agreement products (RepoEdge®) which allow clients to outsource the operational aspects of their collateralized transactions, and Derivatives Margin Management (DM Edge), which helps clients manage credit risks associated with derivatives transactions by enabling them to accept, monitor and re-transfer collateral. These services, among others such as Repo Margin Management (RM Edge), MarginDirect^{SM}, and Derivatives Collateral Net (DCN), may be delivered to clients through AccessEdge^{SM}, a real-time, web-based portal.

The operator/manager of the system and method of this disclosure may act as a third-party service provider to other market participants associated with the financial transactions, and the various functions performed by the system and method may provide value-added services which mitigate risk and lead to greater efficiencies for the other parties.

According to an embodiment, a system for managing collateral in one or more financial transactions, includes one or more processors, at an agent of an asset owner, the one or more processors being configured to execute one or more computer program modules. The program modules are configured to receive first exposure information from a first investment manager associated with the asset owner, the first exposure information comprising a first portion associated with a first counterparty and a second portion associated with a second counterparty. The program modules are also configured to receive second exposure information from a second investment manager associated with the asset owner, the second exposure information comprising a third portion associated with the first counterparty and a fourth portion associated with the second counterparty. The program modules are also configured to net the first portion with the third portion, and the second portion with the fourth portion to compute an exposure for each of the first counterparty and the second counterparty. The program modules are additionally configured to fund a collateral account associated with the agent based on portions of the exposure for each of the first counterparty and the second counterparty attributable to one or more of the first investment manager and the second investment manager. The program modules are further configured to initiate settlement of the exposure for each of the first counterparty and the second counterparty from the collateral account.

According to another embodiment a computer implemented method for managing collateral in one or more financial transactions is implemented in a computer system comprising one or more processors configured to execute one or more computer program modules. The method includes receiving, via the one or more processors, first exposure information from a first investment manager associated with the asset owner, the first exposure information comprising a first portion associated with a first counterparty and a second portion associated with a second counterparty. The method also includes receiving, via the one or more processors, second exposure information from a second investment manager associated with the asset owner, the second exposure information comprising a third portion associated with the first counterparty and a fourth portion associated with the second counterparty. The method also includes netting, via the one or more processors, the first portion with the third portion, and the second portion with the forth portion, to compute an exposure for each of the first counterparty and the second counterparty. The method additionally includes funding, via the one or more processors, a collateral account associated with the agent based on portions of the exposure for each of the first counterparty and the second counterparty attributable to one or more of the first investment manager and the second investment manager. The method further includes initiating settlement of the exposure for each of the first counterparty and the second counterparty from the collateral account.

The system and method of this disclosure provides various capabilities as discussed more fully in the detailed description below.

### BRIEF DISCUSSION OF THE DRAWINGS

FIGS. 1A and 1B illustrate embodiments of a centralized collateral management funding system associated with a credit support annex, between an asset owner, investment managers, and counterparties;

FIG. 2 illustrates an example of initial margin benefits from netting;

FIG. 3 illustrates an embodiment of netting funding requirements across fund managers by associated counterparty;

FIG. 4 illustrates an exemplary process flow for netting, according to an embodiment;

FIG. 5 illustrates Tables 5A-5D, which show by example how aggregating requirements may allow for funding to cover exposures;

FIG. 6 illustrates Tables 6A-6D, showing another example of how aggregating requirements may allow for funding to cover exposures;

FIG. 7 illustrates an exemplary computer system configured to perform the functions of systems and methods described herein; and

FIG. 8 illustrates another embodiment of a system configured to perform the functions of systems and methods described herein.

### DETAILED DESCRIPTION

In the discussion of various embodiments and aspects of the system and method of this disclosure, examples of a processor may include any one or more of, for instance, a personal computer, portable computer, personal digital assistant (PDA), workstation, or other processor-driven device, and examples of network may include, for example, a private network, the Internet, or other known network types, including both wired and wireless networks.

Those with skill in the art will appreciate that the inventive concept described herein may work with various system configurations. In addition, various embodiments of this disclosure may be made in hardware, firmware, software, or any suitable combination thereof. Aspects of this disclosure may also be implemented as instructions stored on a machine-readable medium, which may be read and executed by one or more processors. A machine-readable medium may include any mechanism for storing or transmitting information in a form readable by a machine (e.g., a computing device, or a signal transmission medium), and may include a machine-readable transmission medium or a machine-readable storage medium. For example, a machine-readable storage medium may include read only memory, random access memory, magnetic disk storage media, optical storage media, flash memory devices, and others. Further, firmware, software, routines, or instructions may be described herein in terms of specific exemplary embodiments that may perform certain actions. However, it will be apparent that such descriptions are merely for convenience and that such actions in fact result from computing devices, processors, controllers, or other devices executing the firmware, software, routines, or instructions.

Described herein is an exemplary system which may be implemented through computer software running in a processor to manage collateral aggregation associated with financial transactions on behalf of an asset owner. This description is not intended to be limiting, but is merely provided to describe one way of accomplishing the functions associated with acting as an intermediary on behalf of an asset owner between a plurality of counterparties and a plurality of investment managers.

In the discussion of various embodiments and aspects of the system and method of this disclosure, examples of asset owners include, but are not limited to, pension funds, insurance companies, central banks, sovereign wealth funds, and asset managers with master funds.

In an embodiment, the highest legal entity level of an asset owner may agree to International Swaps and Derivatives Association (ISDA) master agreements and Credit Support Annexes (CSAs) with the trading counterparties (e.g., ISDA counterparties or CSA counterparties, as understood in the art), which may facilitate netting of transactions across investment managers. In an embodiment, the CSA may specify that if an investment manager has to pay out more than it receives in, greater than a threshold amount, then additional collateral may be required to cover exposures as per the agreement between the asset owner and the trading counterparty. The asset owner may set up the ISDA/CSA with the counterparties, which may specify the thresholds, minimum transfer amounts, and how collateral will be covered (e.g., cash, securities, or both) for transfers. Accordingly, the asset owner is allowed to net its exposures at the counterparties away from the investment managers. Such an arrangement may mitigate counterparty risk, and allow for greater efficiency in collateral usage. In an embodiment, a collateral manager may provide collateral management services for the asset owner or plan, which may lack the expertise or resources to manage collateral themselves. It may be appreciated that in an embodiment, the collateral manager may take over such a role from the underlying investment managers of the asset owner or plan, as described in greater detail below.

In an embodiment, a collateral account of the asset owner/plan may be funded by the asset owner transferring in securities and cash (e.g., collectively, collateral) from investment manager accounts. The collateral account may thus be considered a collateral “long box,” containing collateral from a plurality of investment managers. Funding of the long box by the investment managers may occur through one or more mechanisms, which may be at the discretion of the asset owner (e.g., with the agent managing the process). In an embodiment, for example, one investment manager may fund the long box. In an embodiment, alternatively, the agent may move the collateral with the investment managers as if they were dealing directly with the counterparties, but settle on a net basis. In an embodiment, also received collateral may be rehypothecated to cover collateral payments, and then asset owner deficits with counterparties may be requested from one or more of the investment managers. In an embodiment, a lead investment manager may be appointed to cover collateral requirements. For example, the lead investment manager may be the investment manager trading the most over-the-counter (OTC) derivatives, or may have the most eligible collateral. In an embodiment, the asset owner may appoint the lead investment manager based on account of size, or the securities held. The collateral manager may cover the margin requirements from the lead investment manager's account according to a collateral ladder, or may communicate required movements to the lead investment manager and ask for instruction to cover. In an embodiment, the collateral manager may identify assets of selected investment managers (e.g., those who have cash buffer for variation margin), which may be used to cover initial margin. In an embodiment, some or all investment managers may contribute to the long box. For example, each investment manager who trades in derivatives may contribute to the collateral account. Other instructions regarding which investment managers contribute to the long box collateral account may be utilized in other embodiments. It may be appreciated that in some embodiments contribution to the long box by the investment managers may be based on exposure for each counterparty attributable to each investment manager, as described herein.

Having funded the long box, the asset owner or plan may allocate the funding costs back to the investment managers (e.g., on an equitable basis). In an embodiment, the funding costs (e.g., margin usage) may be allocated on a pro-rata basis. In an embodiment, it may be appreciated that fees that are attributable directly to investment managers (e.g., exchange and clearing fees), may be charged as such. In an embodiment, a pension funds collateral pool may allocate net collateral costs back on a usage basis to each investment manager. In an embodiment with a lead investment manager funding the collateral, the costs of net funding may be allocated back to other investment managers on a pro rata basis. In an embodiment, an internal funding process may be performed, such as where the lead investment manager may be credited, and other investment managers may be debited. Again, in an embodiment fees that may be attributable directly to the investment managers may be charged as such. In an embodiment where the collateral manager communicates collateral movements to selected investment managers, the collateral manager may have a pre-determined list of usable collateral, and may review investment manager's accounts for the collateral therein. In an embodiment where some or all investment managers contribute to the long box (e.g., the central collateral pool), compensation of the investment managers on a market basis (e.g., SONIA or Fed rates for cash, and repurchase rates for securities). The net funding cost may be allocated on a usage basis in some embodiments.

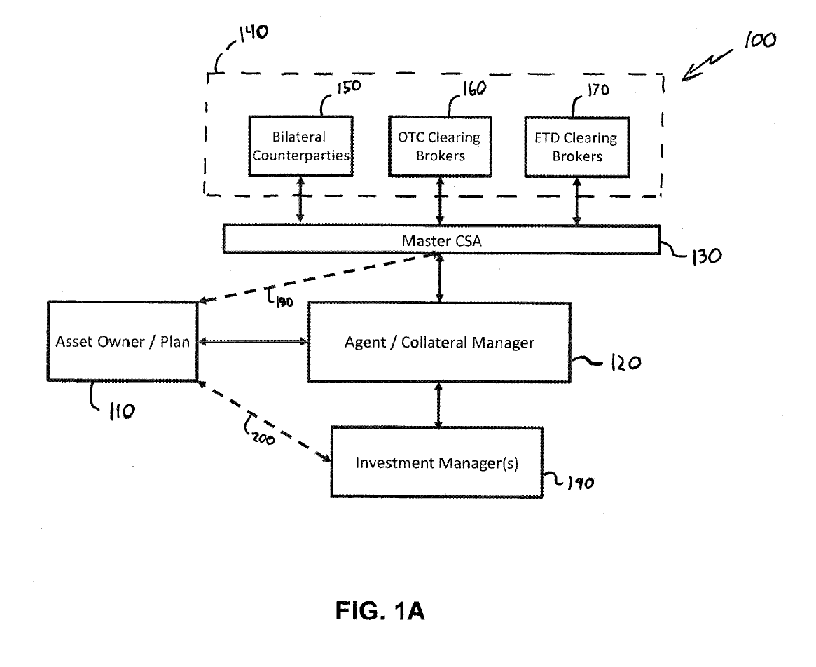

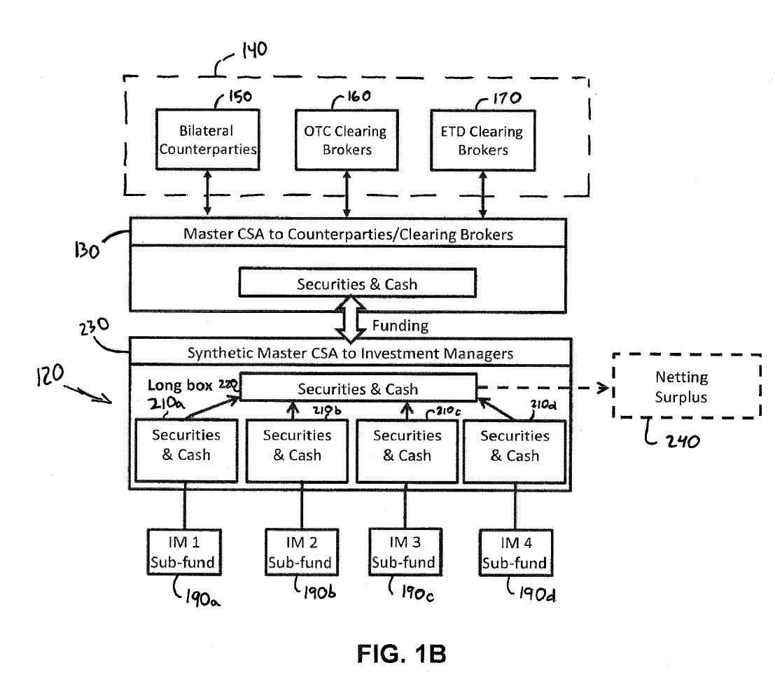

FIG. 1A illustrates an embodiment of a centralized collateral management funding system 100 wherein an asset owner 110 utilizes an agent 120 in managing a credit support agreement or other similar agreement, such as a credit support annex 130, between the asset owner 110 and counterparties 140 to the credit support annex 130. It may be appreciated that the asset owner 110 may vary across embodiments, and in some embodiments may be a pension fund, an insurance company, or other such party traditionally trading under an ISDA or CSA. In an embodiment, the counterparties 140 to the credit support annex 130 may include one or more of bilateral counterparties 150, over the counter (OTC) clearing brokers 160, and exchange traded derivatives (ETD) clearing brokers 170. It may be appreciated that while the asset owner 110 is legally bound to the credit support annex 130, as indicated at 180, interaction between the asset owner 110 and the credit support annex 130, in particular as associated with the funding thereof, may be via the agent 120, as described in greater detail below.

It may be appreciated that funding of the credit support annex 130 may be achieved through one or more investment managers 190. As described herein, the investment managers 190 may manage one or more sub-funds on behalf of the asset owner 110. In an embodiment, while the asset owner 110 may have agreements, such as those regarding collateral allocations) with the investment manager 190 (as indicated at 200), in an embodiment such agreements may be managed through the agent 120, as discussed below.

As illustrated in FIG. 1B, in an embodiment, the agent 120 may manage funding of the credit support annex 130. Specifically, various sub-funds (sub-funds 190a-d in the illustrated embodiment) managed by associated investment managers 190 may transfer their individual securities and cash 210a-d (e.g., assets) to the agent 120, or store their individual securities and cash 210a-d at the agent 120. The securities and cash 210a-d may be netted into a centralized long box 220, which may be utilized as part of a virtual credit support annex 230 to fund the master credit support annex 130 with the counterparties 140. It may be appreciated that the virtual credit support annex 230 may be a virtual account structure maintained at the agent 120, which may replicate the structures of the credit support annex 130 to allow the asset owner 110 to collateralize at a higher legal entity than at the sub-funds 190a-d). In an embodiment, the virtual credit support annex 230 may be characterized as a synthetic master credit support annex, which may be treated analogously to the credit support annex 130 as per parties outside of the agent 120. It may be appreciated that the virtual credit support annex 230 may be constructed between the asset owner 110 (via the agent 120) and the investment managers 190 to fund the collateral requirements and track contribution. The long box 220 may be a custody account that is utilized to pool the collateral received from the investment managers 190 and received or delivered from the counterparties 140. In an embodiment, the virtual credit support annex 230 may be established through an operations memorandum between the asset owner 110 (e.g., via the agent 120) and the investment managers 190. In an embodiment, the master credit support annex 130 may be net margined, and settled from a pool account, such as the long box 220, or an intermediate account associated with the funding from the long box 220. The agent 120, on behalf of the asset owner 110, may additionally utilize the long box 220 to net exposures by counterparty 140, and may reduce collateralization requirements, as described below. In an embodiment, tracking the funding of the long box 220 may comprise tracking which investment manager 190 has contributed what to the long box 220 as the result of a virtual margin call (e.g., as it may be delivered onto the market counterparty 140). Accordingly, the agent 120 may return certain collateral to certain parties, may compute what interest is due to those parties, and may substitute collateral when an income event is due.

It may be appreciated that rehypothecation procedures may be utilized to cover losses associated with one investment manager through gains associated with another investment manager, as per the same counterparty. For example, through netting, if a first investment manager has a $50,000 loss mark to market, and thus must deliver $50,000 in collateral to a particular counterparty, then if a second investment manager has a $100,000 profit mark to market, and would receive $100,000 from the counterparty, the profit associated with the second investment manager may be used to fund the amount owed to the counterparty associated with the first investment manager. It may be appreciated that such rehypothecation may be done at the level of the asset owner, without requiring more complex settlement at the funds level.

In an embodiment, the virtual credit support annex 230 may establish credit support annex and futures commission merchant relationships at the level of the asset owner 110, to enable netting of exposure where possible. Such netting may reduce costs and risk, as described herein. In an embodiment, derivatives transactions and cost/benefits may continue to be tracked at the level of the investment managers 190, which may allow the virtual credit support annex 230 to be transparent in operation relative to the credit support annex 130 agreement between the counterparties 140 and the asset owner 110.

In an embodiment, the centralized long box 220 may be gross margined but net settled with each investment manager 190. In an embodiment, surplus collateral or cash from the netting (e.g., netting surplus 240) may be utilized for any appropriate manner, including but not limited to being reinvested to generate additional returns for the asset owner 110 (e.g., being returned to the investment managers 190 for further investment), being returned to the asset owner 110, or maintained for payment of a future shortage in funding for the credit support agreement 130. While in the illustrated embodiment the netting surplus 240 is illustrated as being taken out of the long box 220, in other embodiments the netting surplus 240 may be maintained within the long box 220, or within any other appropriate account of asset owner 110 or the agent 120.

In an embodiment, the virtual credit support annex 230 may support structures such as those in ISDA master agreements, Global Master Repurchase Agreements (GRMAs), and/or Master Securities Forward Transaction Agreements (MSFTAs). It may be appreciated that such structures may be configured at the virtual credit support annex 230 with underlying sub-funds (e.g., sub-funds 190a-d) and/or associated investment managers 190. In an embodiment, the agent 120 operating the virtual credit support annex 230 may have an existing custody and/or accounting relationship with the asset owner 110, and may, for example, manage or maintain custody accounts associated therewith.

In an embodiment, the agent 120 may operate a collateral management service on behalf of the asset owner 110, so as to interface with the investment managers 190. In an embodiment, the systems of the agent 120 may be configured to appear to the investment managers 190 and/or the underlying sub-funds 190a-d as though they are the counterparties 140, however may instead be at the agent 120, on behalf of the asset owner 110. Accordingly, settlement of collateral may be on a net basis via the long box 220. It may be appreciated that the collateral processes between the agent 120 and the investment managers 190 and/or sub-funds 190a-d may be similar to the agreements in the credit support annex 130 between the asset owner 110 and the counterparties 140. The agent 120, on behalf of the asset owner 110, may then operate a collateral management service between the asset owner 110 and the counterparties 140, as per the terms of credit support agreement 130 (e.g., the ISDA master agreement, GMRA, or MSFTA contracts). In an embodiment, the arrangement of the systems of the agent 120 between the counterparties 140 and the investment managers 190 and/or the sub-funds 190a-d may facilitate equitable funding of the long box 220 as if the investment managers 190 and/or the sub-funds 190a-d were dealing directly on the financial markets (e.g., with the agent 120's participation being generally transparent). In an embodiment, the agreement between the asset owner 110 and the investment managers 190 or sub-funds 190a-d may exist as an operating memorandum, or an addendum to existing agreements therebetween. In an embodiment, the funding of the long box 220 may have associated thresholds which may be configured to achieve at least flat inlays and outlays, and may generally carry a surplus of collateral or cash (e.g., the netting surplus 240) which may be reinvested by the asset owner 110.

As noted above, in an embodiment, utilization of the long box 220 at the agent 120 may be extended to the relationship between the asset owner 110 and their OTC clearing brokers 160 and their ETD clearing brokers 170 (e.g., futures commission merchants). In an embodiment, the futures commission merchants may reflect the structure of the accounts of the asset owner 120 on its own records, similarly to that for the ISDAs. Specifically, the asset owner 120 may be represented as an omnibus account with sub-funds representing the underlying investment managers 190 and/or sub-funds 190a-d. In an embodiment, the savings to the asset owner 110 may be on initial margin, as positions may be netted in the omnibus accounts. In an embodiment, clearing with OTC clearing brokers 160 and ETD clearing brokers 170 may be similar to clearing for ISDAs. For example, the futures commission merchant may provide statements to the underlying sub-funds 190a-d or investment managers 190 at the sub-fund level. The agent 120, on behalf of the asset owner 110, may move collateral with them on that basis via the long box 220 in a transparent manner. On behalf of the asset owner 110, the agent 120 may move collateral with the futures commission merchant via the long box 220 on the basis of the omnibus statement from the futures commission merchant.

In an embodiment, to implement the agent 120 may gross margin but net settle cash and securities 210a-d with each investment manager 190 and/or sub-funds 190a-d. In an embodiment, such settlement may comprise producing reports or data for the investment managers 190 detailing exposures and associated counterparties 140, and receiving the cash and securities 210 from the investment managers 190 to settle and net with the agent 120 on behalf of the asset owner 110. The agent 120 may then fill the long box 220 with the cash and securities 210, and utilize the long box 220 to fund the credit support annex 130, or similar financial arrangements, for settlement with the counterparties 140. It may be appreciated that where portfolios of the investment managers 190 and/or sub-funds 190a-d are in the custody of the agent 120, funding of the long box 220 and/or the virtual credit support annex 230 may be internal transfers at the agent 120, and the agent 120 may move the collateral relative to the counterparties 140 as a custodian.

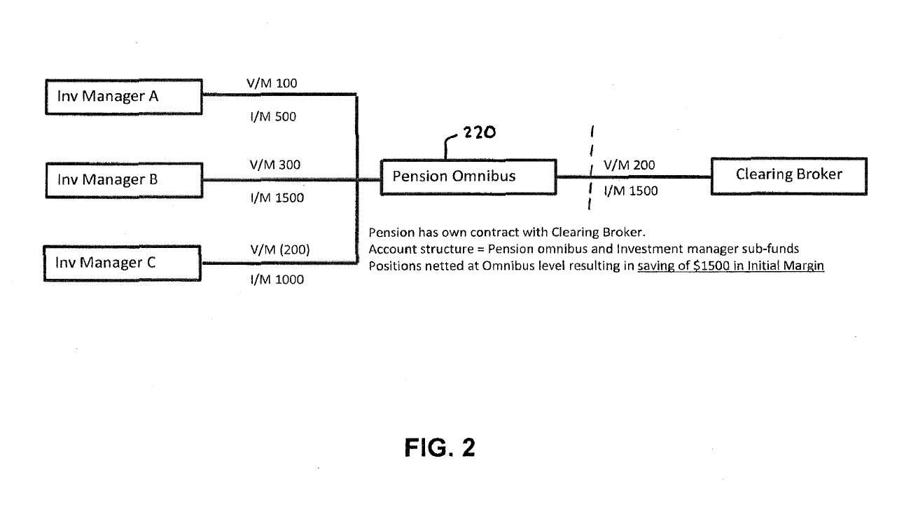

As may be appreciated from FIG. 2, in an embodiment where the long box 220 is utilized in clearing OTC and ETD contracts, by utilizing an omnibus account on behalf of the asset owner 110 (in this case, a pension fund), positions netted at an omnibus level may increase savings in initial margin over configurations where investment managers 190 have direct relationships with clearing brokers (e.g., OTC clearing brokers 160 and ETD clearing brokers 170), with a single account per asset owner. For example, where the initial margin when summed across investment managers A, B, and C is $3,000, and the initial margin to be settled with the clearing broker is $1,500, netting at the omnibus level results in a savings of $1,500. Without such netting, any given investment manager attempting to settle with the clearing broker may be unable to do so without obtaining additional funds from the asset owner 110, or without utilizing the entirety of their initial margin.

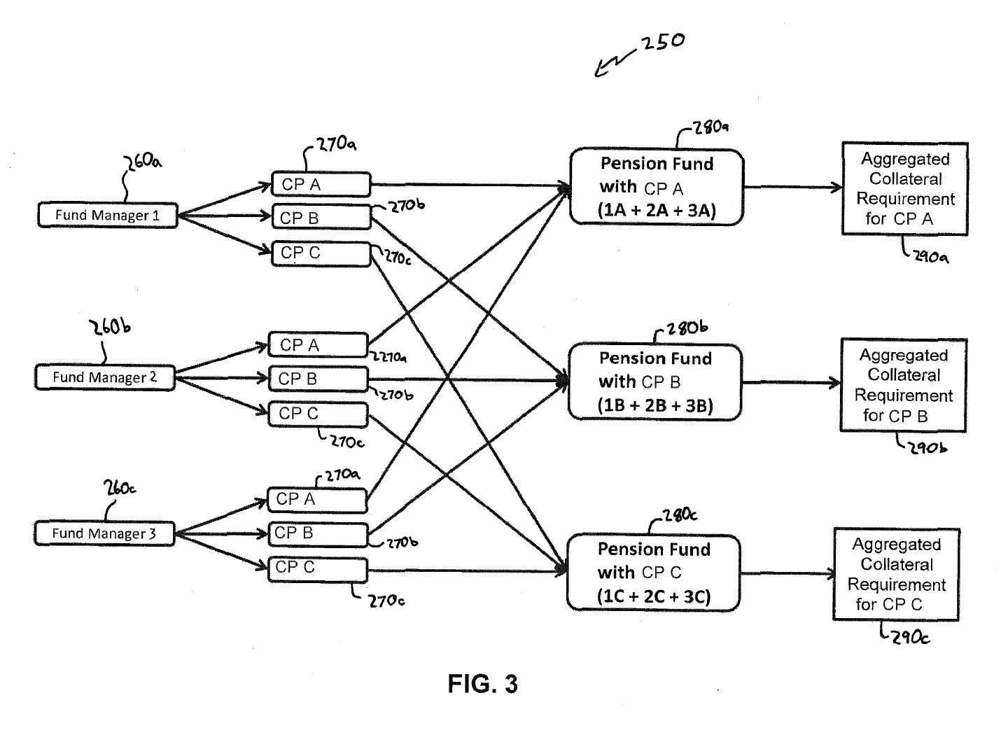

As part of netting securities and cash 210a-d into the long box 220, securities and cash 210a-d may be regrouped, so instead of being grouped by associated investment fund managers (e.g., investment managers 190), the securities and cash 210a-d may be grouped by associated counterparty 140. As shown in FIG. 3, an aggregator algorithm 250 may be implemented on one or more processors (e.g., computer processors) at the agent 120, to aggregate the securities and cash 210a-d associated with different counterparties 140 into an aggregated collateral amount associated with that counterparty 140. For example, in the illustrated embodiment, different investment managers 190 (e.g., fund managers 260a-c) may have securities and cash 210 associated with each of a plurality of counterparties 140 (e.g., counterparty 270a, counterparty 270b, and counterparty 270c). Funds associated with counterparty 270a from each of fund managers 260a, 260b, and 260b may be aggregated into a long box 220 associated with counterparty 270a (specifically, aggregated collateral 280a as illustrated). Similarly, funds associated with counterparty 270b from each of fund managers 260a, 260b, and 260b may be aggregated into a long box 220 associated with counterparty 270b (aggregated collateral 280b), and funds associated with counterparty 270c from each of fund managers 260a, 260b, and 260b may be aggregated into a long box 220 associated with counterparty 270c (aggregated collateral 280c). It may be appreciated that the aggregated collateral 280a may then be utilized to satisfy collateral requirements associated with counterparty 270a, as represented at 290a, while the aggregated collateral 280b may be utilized to satisfy collateral requirements associated with counterparty 270b, as represented at 290b, and the aggregated collateral 280c may be utilized to satisfy collateral requirements associated with the counterparty 280c, as represented at 290c.

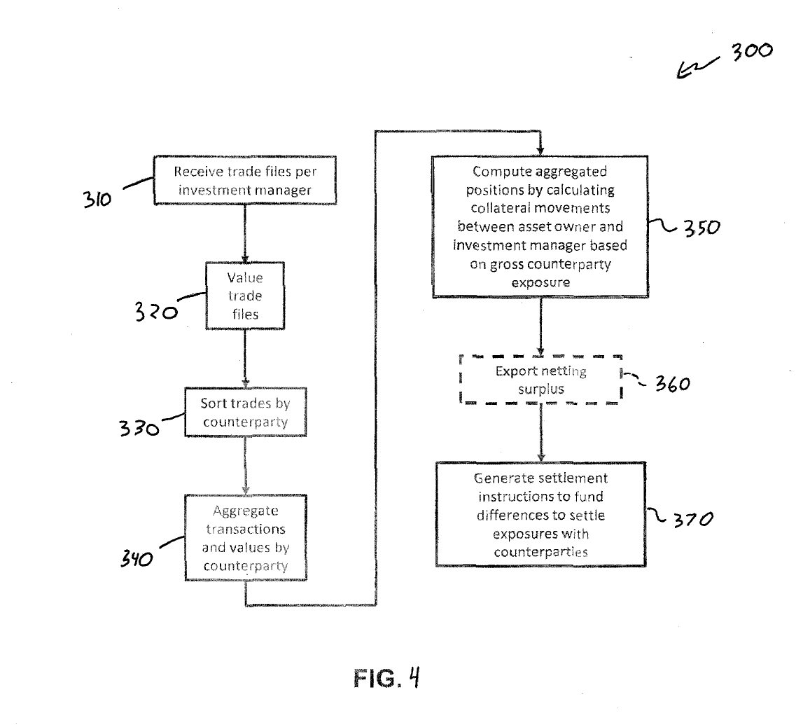

FIG. 4 illustrates an exemplary flowchart showing an embodiment of a process 300 for implementing the aggregator algorithm 250. In an embodiment, the agent 120 has been appointed by the asset owner 110 (e.g., a pension fund), to manage collateral and funding on their behalf. As such, one or more processors at the agent 120 may be configured to receive trade files from the investment managers 190 (e.g., portfolio managers), as illustrated at 310. In an embodiment, receiving the trade files may comprise the agent 120 placing trade information (e.g., details of the trades) into accounts associated with the investment managers 190 or the sub-funds 190a-d, on a collateral system associated with the agent 120. In an embodiment, the processor may then value the trade files at 320. In various embodiments, the agent 120 may perform its own valuation of the trade files, or may receive an evaluation of the trade files from the investment managers 190. The process 300 may then continue at 330 by sorting the trades by counterparty 140, and may then proceed by aggregating (at 340) the transactions and values by counterparty 140. In an embodiment, sorting the trades at 330 may comprise duplicating the trade file, and manipulating information in the duplicated trade file. Aggregating the transactions may be performed in the duplicated trade file, in temporary files or memory, within the processor at the agent 120, or in an associated component thereof. Examples of such aggregation are described in greater detail below. Accordingly, it may be appreciated that in some embodiments the trade files from the investment managers 190 may be duplicated with one file being routed to the virtual credit support annex 230 or equivalent agreement to reflect exposures between the asset owner 100 and the investment managers 190 and the other identical file being routed to the official master credit support annex 130 and the exposures may be aggregated to create an asset owner level between the asset owner 110 (via the agent 120) and the counterparties 140.

In an embodiment, the process 300 may continue at 350 by calculating collateral movements that would otherwise be requested between the asset owner 110 and the investment managers 190. Such collateral movements may be based on the gross exposures to the counterparties 140 by the investment managers 190. In an embodiment, such as that illustrated, the calculated collateral movements may be utilized in computing aggregated positions between the agent 120 (on behalf of the asset owner 110) and the counterparties 140. In an embodiment, the calculation at 350 may comprise determining the exposure value of the trades, determining the collateral in place associated with that counterparty 140, and determining whether additional collateral should be requested to satisfy obligations with the counterparty 140. In an embodiment, the aggregated cash amounts and securities positions may be stored in the long box 220, which in an embodiment may be an actual custody account at the agent 120.

In an embodiment, where there is a surplus determined between the asset owner 110 and the counterparties 140 in the aggregation computed at 350, the surplus may be exported (e.g., set aside within the long box 220, or transferred out), as shown at 360. As noted above with regard to netting surplus 240, the surplus may be utilized for any appropriate manner, including but not limited to being reinvested to generate additional returns for the asset owner 110 (e.g., being returned to the investment managers 190 for further investment), being returned to the asset owner 110, or maintained for payment of a future shortage in funding for the credit support agreement 130 between the asset owner 110 and the counterparties 140. In an embodiment, a subset of the netting surplus 240 may be returned to the asset owner 110, while another subset of the netting surplus 240 may be distributed to the investment managers 190 for further investment on behalf of the asset owner 110.

In an embodiment, after the aggregated positions are computed at 350, settlement instructions may be generated at 370 to fund deficiencies in the positions, as owed between the asset owner 110 and the counterparties 140. In an embodiment, the agent 120 may settle the differences (e.g., by funding the credit support annex 130, and settling with the counterparties 140). In other embodiments, such as where third party custodians are utilized while the agent 120 computes and/or manages the transactions, the settlement instructions may be transmitted to the third party custodians for settlement with the counterparties 120.

It may be appreciated that the process 300 may be run periodically, including but not limited to daily, weekly, monthly, or so on. In an embodiment, the process 300 may be run each time the collateral is fully utilized, and additional cash or collateral is needed for funding obligations with the counterparties 140. In an embodiment, data in the trade files received at 310 may be from the prior day (e.g., the close of the prior day). In other embodiments, the process 300 may be run more often, such as throughout the day, depending on the terms of the credit support annex 130, or other agreement between the asset owner 110 and the counterparties 140. In an embodiment, funding of the long box 220 may be on a received before given basis. In some embodiments, funding of the long box 220 from the investment managers 190 may thus be in the morning, or overnight (once exposure from the prior day's transactions is computed).

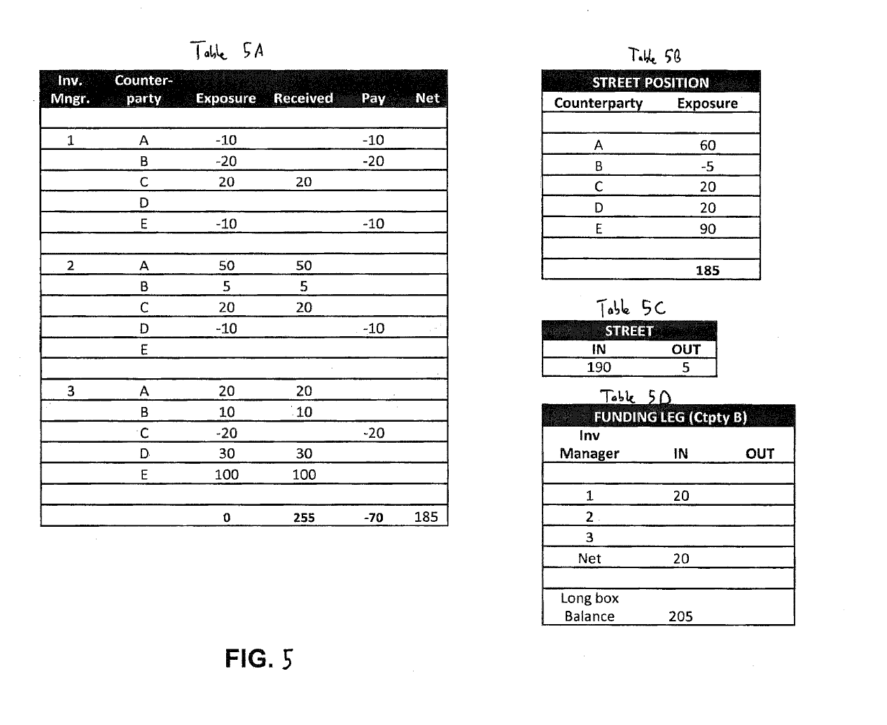

FIG. 5 illustrates Tables 5A-5D, illustrating an example of three investment managers (Inv. Manager 1, Inv. Manager 2, and Inv. Manager 3 in Table 5A), all trading with five counterparties (Counterparties A-E), for a single asset owner. In the example, the Exposure column may be their position at a present time. In the example, $255 is being received, while $70 is being paid out, as shown in Table 5A with the received and paid funds per counterparty associated with each investment manager. It may be appreciated that these figures are purely for the sake of example, and much larger figures may be traded when implemented. Where the exposure is negative, the counterparties are owed money, and need the asset owner is obligated to cover that, while where the exposure is listed as positive, the counterparty has money, and the asset owner should receive funds. As shown in Table 5B, the process 300 may aggregate the asset owner's exposure per counterparty, which sums to $185, where $5 is paid out to counterparty B, while 190 is received from counterparties A, C, D, and E (as summed in Table 5C). As shown in Table 5D, because Inv. Manager 1 is obligated to provide $20 for counterparty B, to fund counterparty B, the agent 120 may call for $20 from Inv. Manager 1, giving a long box balance of $205, which is more than sufficient to cover the funding for Counterparty B. It may be appreciated that in an embodiment, Inv. Manager 1 may benefit from the netting in the long box, because they would not be called to provide funds to cover exposure as per Counterparty A (to which they would otherwise owe $10), or Counterparty E (to which they would also otherwise owe $10).

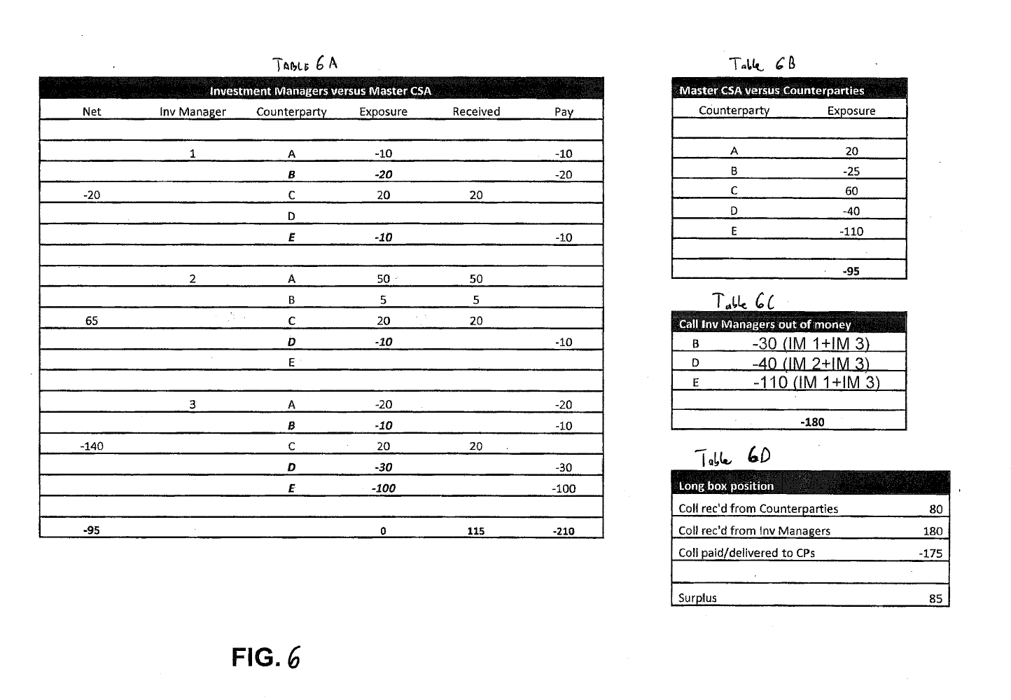

FIG. 6 illustrates a different example, in Tables 6A-6D. Table 6A shows the same breakdown of Counterparties A-E associated with each investment manager (Inv. Managers 1-3), however with less net receives ($115), which is less than the amount they have to pay out ($210). As consolidated by counterparty in Table 6B, the net exposure to the counterparties is $95, with $80 coming in, but $175 going out. Accordingly, there is not enough collateral received to cover collateral that needs to be paid out or delivered to the counterparties. In an embodiment, the collateral that comes into the agent 120 would not then be moved down to the investment managers 190, but would be held at the agent 120, and be paid out on an as needed basis. If it runs out, then the agent may request collection from the investment managers 190, as would be the case in FIG. 6. To cover the $95 exposure, the agent may call for replenishment for those counterparties B, D, and E who are “out of the money,” having paid more across counterparties than received, and thus having exposure (e.g., negative values as depicted in Tables 6A and 6B), as summarized in Table 6C. It may be appreciated that the agent 120 receiving funding from the investment managers 190 may (to the investment managers 190) be analogous to their settling with the counterparties 140, as described above. In the example of FIG. 6, since counterparty B has $25 of exposure, the agent 120 may collect $20 form Inv. Manager 1, and $10 from Inv. Manager 3, as per their contractual agreements, to collect $30 as shown in FIG. 6C. Similarly, since counterparty D is out $40, the agent may call Inv. Manager 2 for $10, and Inv. Manager 3 for $30. Further, the agent 120 may collect for counterparty E, because they are out $110 (collecting $10 from Inv. Manager 1 and $100 from Inv. Manager 3). As shown in Table 6D, $180 may be received to cover the $95 in deficit.

In an embodiment, the call to investment managers 190 may be just to those who owe money to cover their shortage. For example, to cover the $95 deficit from Table 6B, since Inv. Manager 3 owes $100 for counterparty E (as shown in Table 6A), a call may be just to Inv. Manager 3, to collect sufficient funds to cover all exposure. In another embodiment, the call to investment managers 190 may be pro-rated across how much each investment manager 190 is obligated to provide (e.g., to make up the $95, the $95 may be divided across Inv. Managers 1-3, possibly based on how much they owe relative to the counterparties with exposure associated with their management).

Accordingly, it may be appreciated that the long box 220 may facilitate the raising of variable funding depending on how the asset owner 110 wants to move collateral with the underlying investment managers should the collateral coming be less than that going out. As the relationship between the asset owner and the counterparty is governed by the credit support annex, by having the virtual credit support annex, the relationship between the asset owner and the investment manager may be more flexible. In an embodiment, an addendum to the agreements between the investment manager and the asset owner may direct that the process be run via the agent.

Those skilled in the art will appreciate that the embodiments described herein can be implemented using a server, computer, database, communications and programming technology, each of which implements hardware or software or any combination thereof. Embodiments of this disclosure may be implemented in the form of a computer program product on a computer-readable storage medium having computer-readable program code means embodied in any suitable computer-readable storage medium, including hard disks, CD-ROM, RAM, ROM, optical storage devices, magnetic storage devices, and/or the like.

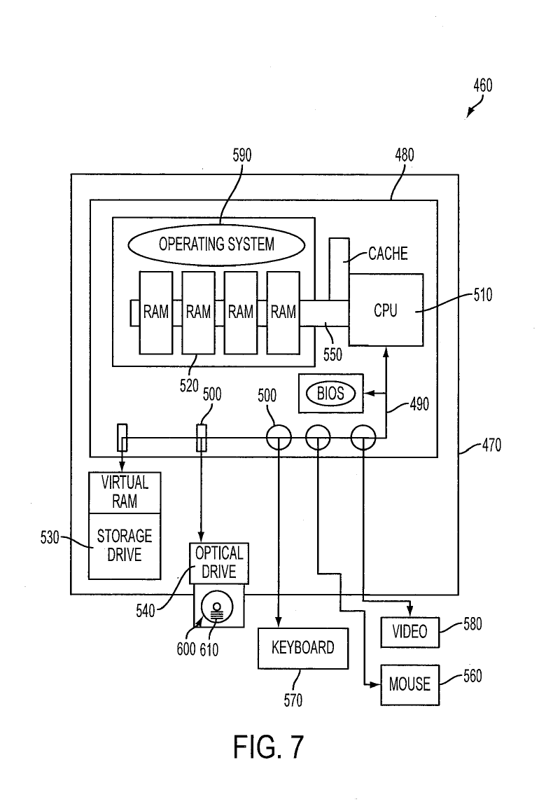

For example, FIG. 7 illustrates a high level block diagram of an exemplary computer system 460 which may be used to perform embodiments of the processes disclosed herein, including but not limited to process 300. It may be appreciated that in some embodiments, the system performing the processes herein may include some or all of the computer system 460. In some embodiments, the computer system 460 may be linked to or otherwise associated with other computer systems 460. In an embodiment the computer system 460 has a case 470, enclosing a main board 480. The main board has a system bus 490, connection ports 500, a processing unit, such as Central Processing Unit (CPU) 510, and a data storage device, such as main memory 520, storage drive 530, and optical drive 540. Each of main memory 520, storage drive 530, and optical drive 540 may be of any appropriate construction or configuration. For example, in some embodiments storage drive 530 may comprise a spinning hard disk drive, or may comprise a solid-state drive. Additionally, optical drive 540 may comprise a CD drive, a DVD drive, a Blu-ray drive, or any other appropriate optical medium.

Memory bus 550 couples main memory 520 to CPU 510. A system bus 590 couples storage drive 530, optical drive 540, and connection ports 500 to CPU 510. Multiple input devices may be provided, such as for example a mouse 560 and keyboard 570. Multiple output devices may also be provided, such as for example a video monitor 580 and a printer (not shown). In an embodiment, such output devices may be configured to display information regarding the processes disclosed herein, including but not limited to cash amounts, trade details, and so on. It may be appreciated that the input devices and output devices may alternatively be local to the case 470 and the computer system 460, or may be located remotely (e.g., interfacing with the computer system 460 through a network or other remote connection).

Computer system 460 may be a commercially available system, or may be proprietary design. In some embodiments, the computer system 460 may be a desktop workstation unit, and may be provided by any appropriate computer system provider. In some embodiments, computer system 460 comprise a networked computer system, wherein memory storage components such as storage drive 530, additional CPUs 510 and output devices such as printers are provided by physically separate computer systems commonly tied together in the network. Those skilled in the art will understand and appreciate the physical composition of components and component interconnections comprising computer system 460, and select a computer system 460 suitable for performing the methods disclosed herein.

When computer system 460 is activated, preferably an operating system 590 will load into main memory 520 as part of the boot sequence, and ready the computer system 460 for operation. At the simplest level, and in the most general sense, the tasks of an operating system fall into specific categories—process management, device management (including application and user interface management) and memory management.

In such a computer system 460, the CPU 510 is operable to perform one or more embodiments of the methods described above. Those skilled in the art will understand that a computer-readable medium 600 on which is a computer program 610 for performing the methods disclosed herein may be provided to the computer system 460. The form of the medium 600 and language of the program 610 are understood to be appropriate for computer system 460. Utilizing the memory stores, such as one or more storage drives 530 and main system memory 520, the operable CPU 510 will read the instructions provided by the computer program 610 and operate to perform the methods disclosed herein, such as process 300.

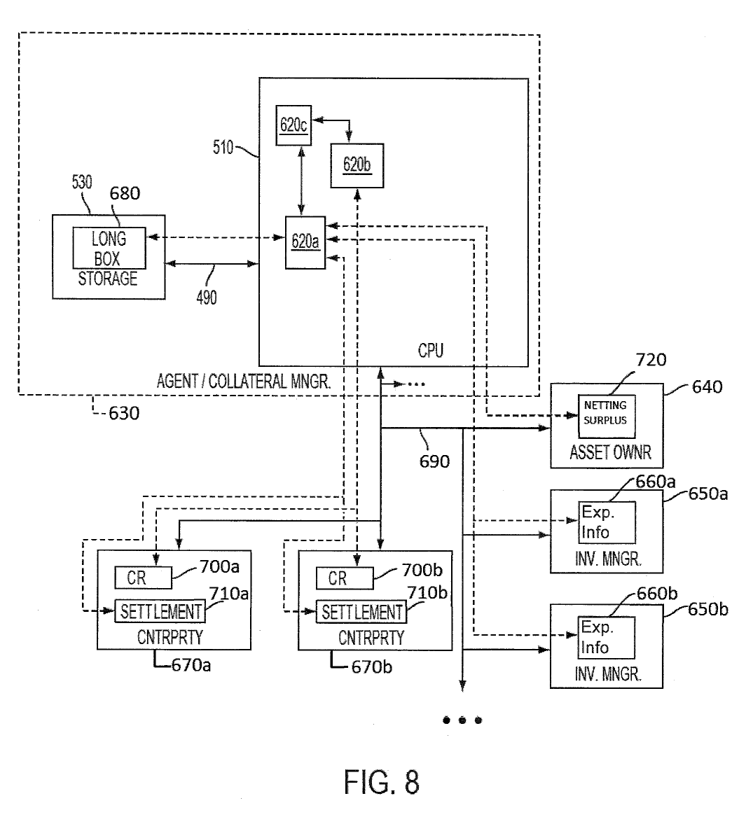

As shown in FIG. 8, in some embodiments the CPU 510 (either alone or in conjunction with additional CPUs 510) may be configured to execute one or more computer program modules 620, each configured to perform one or more functions of the processes described herein. For example, in the illustrated embodiment, at a CPU 510 operated by an agent 630 of an asset owner 640, a computer program module 620a may be configured to receive from a first investment manager 650a exposure information 660a. In an embodiment, the asset owner 640 may be similar to the asset owner 110 described above It may be appreciated that the exposure information 660a may include a portion associated with a first counterparty 670a, and a portion associated with a second counterparty 670b. The counterparties 670a and 670b may be similar to the counterparties 140 described above. The computer program module 620a may also be configured to receive from a second investment manager 650b exposure information 660b, which may include a portion associated with the first counterparty 670a, and a portion associated with the second counterparty 670b. In an embodiment, the exposure information 660a and 660b (generically exposure information 660) may include an accounting of assets or liabilities (e.g., the positive or negative amounts associated with each investment manager 190 for each counterparty 140). It may be appreciated that the first and second investment managers 650a and 650b may be similar to the investment managers 190 described above.

The computer program module 620a may be configured to access and manipulate, on electronic storage media such as the storage drive 530, asset and collateral information for a collateral account 680 associated with the asset owner 640. The storage drive 530 may be linked to the CPU 510 via the system bus 490, through a network (e.g., a network 690), or any other appropriate data link. The computer program module 620a may also be configured to aggregate the exposure information 660a and the exposure information 660b into the collateral account 680. In an embodiment, the portions of the assets or liabilities associated with the first counterparty 670a may be netted with the portions of the assets or liabilities associated with the second counterparty 670b, as described in greater detail above.

In an embodiment, the computer program module 620a may be configured to initiate settlement of collateral requirements 700 (individually collateral requirements 700a and 700b in the illustrated embodiment) from one or more of the first counterparty 670a and the second counterparty 670b. As shown, in an embodiment the CPU 510 may be configured to execute a computer program module 620b configured to receive collateral requirements 700a and 700b from the first counterparty 670a and the second counterparty 670b. It may be appreciated that the collateral requirements 700a and 700b may be associated with the funding of a credit support annex, such as credit support annex 130. As shown, in an embodiment the computer program module 620a, configured to access the collateral account 680, may be configured to transmit the settled amount from the collateral account 680 to the counterparties 670a and 670b (e.g., as settlement 710a and settlement 710b in the illustrated embodiment).

In an embodiment, the computer program module 620b may be interfaced directly with the computer program module 620a coupled to the collateral account 680. Accordingly, when the collateral requirement 700 is received from the counterparties 670 (or otherwise calculated based on information from one or more of the counterparties 670, the investment managers 660, the asset owner 640, the credit support annex 130, and any other data source), the program module 620b may instruct the program module 620a to release the funding amount (e.g., the settlement 710) to settle with the counterparties 670 according to the terms of the credit support annex 130, or as otherwise required (e.g., through a broader ISDA master agreement). As shown in the illustrated embodiment, the module 620b may be interfaced with the module 620a that is linked with the collateral account 680 by a program module 620c, which in an embodiment may direct and coordinate the program modules 620a and 620b. In effect, in an embodiment, a plurality of modules 620, operating over one or more CPUs 510, may cooperate with one another to perform the methods described herein.

In the illustrated embodiment, computer program module 620a may be configured to release surplus assets 720 received not utilized in the settlement with the counterparties 670a and 670b out of the collateral account 680. While in the illustrated embodiment, the surplus assets 720 are provided to the asset owner 640, in other embodiments the surplus assets 720 may be provided to one or more of the investment managers 650a and 650b, as exposure information 660, which may be utilized in further investments on behalf of the asset owner 640. Accordingly, it may be appreciated that the network 690 may be configured to effectuate electronic funds transfers and other financial and/or data exchanges. In an embodiment, electronic funds and security transfers may be routed through one or more specific networks associated with such transactions. In an embodiment, one or more of the modules, including, for example, module 620a, may be configured to perform the settlement with the counterparties 670, such as by rehypothecating assets and collateral within the collateral account 680, and utilizing the funds therein to settle obligations with the counterparties 670, or may be configured to generate settlement instructions which may be transferred to another party for settlement.

The above-discussed embodiments and aspects of this disclosure are not intended to be limiting, but have been shown and described for the purposes of illustrating the functional and structural principles of the inventive concept, and are intended to encompass various modifications that would be within the spirit and scope of the following claims.

Various embodiments may be described herein as including a particular feature, structure, or characteristic, but every aspect or embodiment may not necessarily include the particular feature, structure, or characteristic. Further, when a particular feature, structure, or characteristic is described in connection with an embodiment, it will be understood that such feature, structure, or characteristic may be included in connection with other embodiments, whether or not explicitly described. Thus, various changes and modifications may be made to this disclosure without departing from the scope or spirit of the inventive concept described herein. As such, the specification and drawings should be regarded as examples only, and the scope of the inventive concept to be determined solely by the appended claims.

1. A system for managing collateral in one or more financial transactions, the system comprising one or more processors, at an agent of an asset owner, the one or more processors configured to execute one or more computer program modules, the program modules being configured to:
receive first exposure information from a first investment manager associated with the asset owner, the first exposure information comprising a first portion associated with a first counterparty and a second portion associated with a second counterparty;
receive second exposure information from a second investment manager associated with the asset owner, the second exposure information comprising a third portion associated with the first counterparty and a fourth portion associated with the second counterparty;
net the first portion with the third portion, and the second portion with the fourth portion to compute an exposure for each of the first counterparty and the second counterparty;
fund a collateral account associated with the agent based on portions of the exposure for each of the first counterparty and the second counterparty attributable to one or more of the first investment manager and the second investment manager; and
initiate settlement of the exposure for each of the first counterparty and the second counterparty from the collateral account.

2. The system of claim 1, wherein the asset owner, the first counterparty, and the second counterparty are bound by one or more of an international swaps and derivatives association master agreement and a credit support annex.

3. The system of claim 1, wherein the one or more program modules are configured to initiate settlement of the exposure for each of the first counterparty and the second counterparty by generating settlement instructions.

4. The system of claim 3, wherein the agent executes the settlement instructions to settle the exposure for each of the first counterparty and the second counterparty.

5. The system of claim 1, wherein the one or more program modules are configured to initiate settlement of the exposure for each of the first counterparty and the second counterparty by rehypothecating a profit associated with the first investment manager to cover a loss associated with the second investment manager.

6. The system of claim 6, wherein the first exposure information and the second exposure information are received in a form comprising trade files.

7. The system of claim 6, wherein the trade files comprise values of trades made by one or more of the first investment manager and the second investment manager.

8. The system of claim 6, wherein the program modules are further configured to value trades identified in the trade files, to determine exposure amounts to be covered.

9. The system of claim 1, wherein the asset owner comprises a pension fund or an insurance company.

10. The system of claim 1, wherein each of the first counterparty or the second counterparty comprises one or more of a bilateral counterparty, an over the counter clearing broker, or an exchange traded derivative clearing broker.

11. The system of claim 1, wherein each of the first counterparty or the second counterparty comprises one or more sub-funds comprising assets managed on behalf of the asset owner.

12. The system of claim 1, wherein at least a portion of surplus assets in the collateral account are transferred out of the collateral account.

13. The system of claim 12, wherein the portion of the surplus assets are transferred into custody of one or more of the asset owner, the first investment manager, and the second investment manager.

14. A computer implemented method for managing collateral in one or more financial transactions, wherein the method is implemented in a computer system comprising one or more processors, at an agent of an asset owner, configured to execute one or more computer program modules, the method comprising:
receiving, via the one or more processors, first exposure information from a first investment manager associated with the asset owner, the first exposure information comprising a first portion associated with a first counterparty and a second portion associated with a second counterparty;
receiving, via the one or more processors, second exposure information from a second investment manager associated with the asset owner, the second exposure information comprising a third portion associated with the first counterparty and a fourth portion associated with the second counterparty;
netting, via the one or more processors, the first portion with the third portion, and the second portion with the forth portion, to compute an exposure for each of the first counterparty and the second counterparty;
funding, via the one or more processors, a collateral account associated with the agent based on portions of the exposure for each of the first counterparty and the second counterparty attributable to one or more of the first investment manager and the second investment manager; and
initiating settlement of the exposure for each of the first counterparty and the second counterparty from the collateral account.

15. The method of claim 14, wherein the asset owner, the first counterparty, and the second counterparty are bound by one or more of an international swaps and derivatives association master agreement and a credit support annex.

16. The method of claim 14, wherein initiating settlement of the exposure for each of the first counterparty and the second counterparty comprises generating settlement instructions.

17. The method of claim 16, further comprising executing the settlement instructions to settle the exposure for each of the first counterparty and the second counterparty.

18. The method of claim 14, wherein initiating settlement of the exposure for each of the first counterparty and the second counterparty comprises rehypothecating a profit associated with the first investment manager to cover a loss associated with the second investment manager.

19. The method of claim 14, wherein receiving the first exposure information and the second exposure information comprises receiving trade files.

20. The method of claim 19, wherein the trade files comprise values of trades made by one or more of the first investment manager and the second investment manager.

21. The method of claim 19, further comprising valuing trades identified in the trade files, to determine exposure amounts to be covered.

22. The method of claim 14, wherein the asset owner comprises a pension fund or an insurance company.

23. The method of claim 14, wherein each of the first counterparty or the second counterparty comprises one or more of a bilateral counterparty, an over the counter clearing broker, or an exchange traded derivative clearing broker.

24. The method of claim 14, wherein each of the first counterparty or the second counterparty comprises one or more sub-funds comprising assets managed on behalf of the asset owner.

25. The method of claim 14, further comprising transferring at least a portion of surplus assets in the collateral account out of the collateral account.

26. The method of claim 25, wherein the portion of the surplus assets are transferred into custody of one or more of the asset owner, the first investment manager, and the second investment manager.
